(19) United States
(12) Patent Application Publication
(10) Pub. No.: US 2016/0297406 A1
(43) Pub. Date: Oct. 13, 2016

(54) ARRANGEMENT AND METHOD FOR ACTUATING AT LEAST ONE WINDSHIELD WIPER AND/OR WINDSHIELD CLEANING SYSTEM

(71) Applicant: ZF Friedrichshafen AG, Friedrichshafen (DE)

(72) Inventors: Christian Jansen, Meckenbeuren (DE); Mathias HÄUSLMANN, Amberg (DE); Jörg DITTRICH, Amberg (DE)

(73) Assignee: ZF Friedrichshafen AG, Friedrichshafen (DE)

(21) Appl. No.: 15/037,385

(22) PCT Filed: Nov. 14, 2014
(86) PCT No.: PCT/EP2014/074550

§ 371 Date: May 18, 2016

(30) Foreign Application Priority Data
Dec. 16, 2013 (DE) 10 2013 225 972.7

(51) Int. Cl. B60S 1/48; B60S 1/08

(52) U.S. Cl. CPC B60S 1/485; B60S 1/0818; B60S 1/0825

(57) ABSTRACT

The invention proposes an arrangement for controlling a windshield wiper system and/or windshield washer system of a vehicle, having at least one sensor for recording ambient parameters, which sensor is connected via a control unit for purposes of controlling with a drive unit of the windshield wiper system and/or windshield washer system. The control unit is connected with a correction request recording actuating element of the windshield wiper system and/or windshield washer system, for providing adaptive control. Furthermore, the invention proposes a method for adapting a characteristic diagram for controlling a windshield wiper system and/or windshield washer system, depending on ambient parameters, wherein the actuating intensity of the windshield wiper system and/or windshield washer system stored in a characteristic diagram, depending on multiple ambient parameters, is changed and stored individually, depending on a correction request by the driver. Finally, the invention proposes a method for controlling a windshield wiper system and/or windshield washer system of a vehicle, depending on ambient parameters, wherein the windshield wiper system and/or windshield washer system is activated when a determinable rain intensity and/or a determinable contamination level and/or a determinable release time is reached.

### BACKGROUND

1. Technical Field

The present invention relates to an arrangement for controlling at least a windshield wiper system and/or windshield washer system of a vehicle according to the type described in the preamble of Claim 1. In addition, the invention relates to a method for adapting a characteristic diagram for controlling the windshield wiper system and/or windshield washer system of a vehicle according to the type described in the preamble of Claim 6. Finally, the invention relates to a method for controlling the windshield wiper system and/or windshield washer system of a vehicle according to the type described in the preamble of Claim 9.

2. Background Information

For example, the publication DE 197 42 657 A1 discloses a wiper device for controlling a windshield wiper in a vehicle. This well-known wiper device provides a central electronic unit which controls the windshield wiper motor. A rain sensor supplies sensor signals to the central electronic unit for automatically controlling the windshield wiper.

For example, it is possible to use a rain sensor in the form of an optical sensor, which can detect the moistening of the windshield with water via the reflection of a light beam. This is accomplished by comparing determined reflection values with stored comparative values to generate a specific reaction, for example, continuous or interval wiping.

The well-known device involves the problem that the predetermined values do not allow for an individual or situation-specific adaptation to other ambient parameters.

### BRIEF SUMMARY

The present invention is based on the objective of providing an arrangement and a method for an optimized process of wiping and cleaning vehicle windows, wherein the control of a windshield wiper and windshield washer system is performed in consideration of different ambient parameters.

This problem is solved by means of an arrangement for controlling at least a windshield wiper system and/or windshield washer system of a vehicle, in which at least one sensor or the like is provided for recording ambient parameters, which is connected with a drive unit of the arrangement for controlling via a control unit. Advantageously, it is provided that the control unit or the like is connected with a correction request recording actuating element or the like of the windshield wiper system and/or windshield washer system to be able to adapt the control system. It is also possible to control additional systems, arrangements or elements of the vehicle by means of this arrangement.

A windshield wiper system depicts a device by means of which visual obstructions on the vehicle window caused by liquids, for example rainfall, are eliminated by removing the liquid from the vehicle window at least in a determined area. Preferably, this involves well-known windshield wipers.

Moreover, a windshield washer system depicts a device by means of which a cleaning agent is applied to the car window in order to remove contaminants. For example, the cleaning agent can involve water, but the cleaning agent can also be mixed with different proportions of cleaning additives. These cleaning additives involve specific additives for removing general contaminants, such as dust or insects, as well as additives for lowering the freezing level of the cleaning agent.

In the proposed arrangement, the invention-based adaptation is achieved in that the correction request recorded via the actuating element is stored via the control unit in a data memory or the like, which is connected with the control unit. In the process, the values stored, for example, in a characteristic diagram, depending on one or multiple ambient parameters, are appropriately adapted, based on the recorded correction values.

For recording the ambient parameters, the arrangement can be provided with different types of sensors or the like, which are able to record the ambient parameters appropriately. For example, the sensors can be directly mounted in the windows of the vehicle or at a different appropriate position.

The proposed arrangement can be used also in vehicles with autonomous drive mode. Here, in addition to controlling the windshield wiper system and/or windshield washer system, it is also possible to control different components of the vehicle, for example, opening and closing the windows, turning the lighting on and off or the like.

The invention-based objective is also achieved by means of a method for adapting a characteristic diagram for controlling the windshield wiper system and/or windshield washer system, depending on ambient parameters. In this method, the actuating or wiping intensity or the like stored in the characteristic diagram, depending on respective ambient parameters, for example, for controlling the windshield wiper system and/or windshield washer system, depending on correction requests entered by the driver, is changed and subsequently stored.

As a result, a method is proposed for individually controlling a windshield wiper system and/or windshield washer system by using sensors, which record ambient parameters, for example, rain sensors, contaminant sensors or other sensors. With this method, it is possible to implement a desired control of wiping intensity, also length of the interval, wiping speed or the like for different input parameters, such as speed, brightness, rain intensity or the like in accordance with the currently prevalent or actual ambient conditions. Consequently, it is possible to provide a situation-based adaptation on the basis of ambient conditions and, in addition to storing manually, it is possible to assign and store automatically the desired wiping intensity by means of an appropriate algorithm.

By means of the appropriate algorithm, it is possible, for example, to approximate neighboring values in the characteristic diagram when an accumulation of correction requests or adaptation occurrences can be determined and the correction requests can be attributed to the same ambient condition or multiple identical conditions. Via an approximation function, it is also possible to make an adaptation of values situated between two correction requests or performed changes in the characteristic diagram in accordance with the correction requests or changes of the neighboring values. In addition, by assessing the correction requests, it is possible to perform an evaluation of important ambient parameters, and thus an estimation of potential changes can be made in the characteristic diagram in the form of a preventive change of the stored values, taking into consideration the evaluated ambient parameters.

It may be necessary to classify the ambient conditions. This can mean, for example, that the vehicle speed is classified in the form of speed categories. As a result, it is possible to reduce the data volume with regard to the characteristic diagram. At the same time, the correction requests and changes have a more harmonious effect on the operation of the windshield wiper and windshield washer system. This is the case because correction requests have an effect on a wider range of values when they are appropriately classified. If the storage of the values in the characteristic diagram is too comprehensive, this could result in a considerably prolonged learning phase, as well as in the fact that constant changes of the wiping intensity of the windshield wiper and windshield washer system could be considered to be disturbing.

In the context of a variation of the proposed method, it is possible to provide an assessment of the previous correction requests of the driver or user by means of the control unit in order to adapt or estimate the stored values for other ambient conditions. In this way, the already recorded correction requests are also transferred to other ambient parameters, so that there is basically already an advance adaptation. If required, this adaptation makes it possible to evaluate, for example, the wiping intensity when there is lower brightness or to change the desired wiping intensity according to personal preference when there is a great variation of brightness due to a change in rain intensity.

The invention-based objective is also achieved by means of a method for controlling the windshield wiper system and/or windshield washer system of a vehicle, depending on ambient parameters, in which the windshield wiper system and/or windshield washer system is activated when a predetermined rain intensity and/or predetermined contamination level and/or predetermined release time is reached.

In this way, an intelligent method is proposed for controlling at least windshield wiper systems and/or windshield washer systems of vehicles with not only normal drive mode, but also autonomous drive mode. Besides passenger cars, this field of application could be used also for other vehicles, for example, buses, trucks or even railway vehicles. At the same time, the application is not restricted to windshields, but can be used also for rear windows or other glass windows.

It is possible that the proposed methods can be used also with the proposed arrangement. However, it is also possible that the invention-based methods are used with different arrangements.

### BRIEF DESCRIPTION OF THE DRAWINGS

Subsequently, the present invention is described in more detail by means of the drawings. It is shown:

FIG. 1: a schematic view of a possible embodiment of an invention-based arrangement for controlling a windshield wiper system and/or windshield washer system of a vehicle;

FIGS. 2A-2D: schematic views of an adapted characteristic diagram of stored wiping intensities;

FIGS. 3A-3C: temporal presentations of the vehicle speed, rain intensity and wiping intensity;

FIG. 4: a block diagram of a possible embodiment of an invention-based method for controlling the windshield wiper system and/or windshield washer system;

FIG. 5: a table with different ambient parameters for controlling the system.

### DETAILED DESCRIPTION OF THE DRAWINGS AND THE PRESENTLY PREFERRED EMBODIMENTS

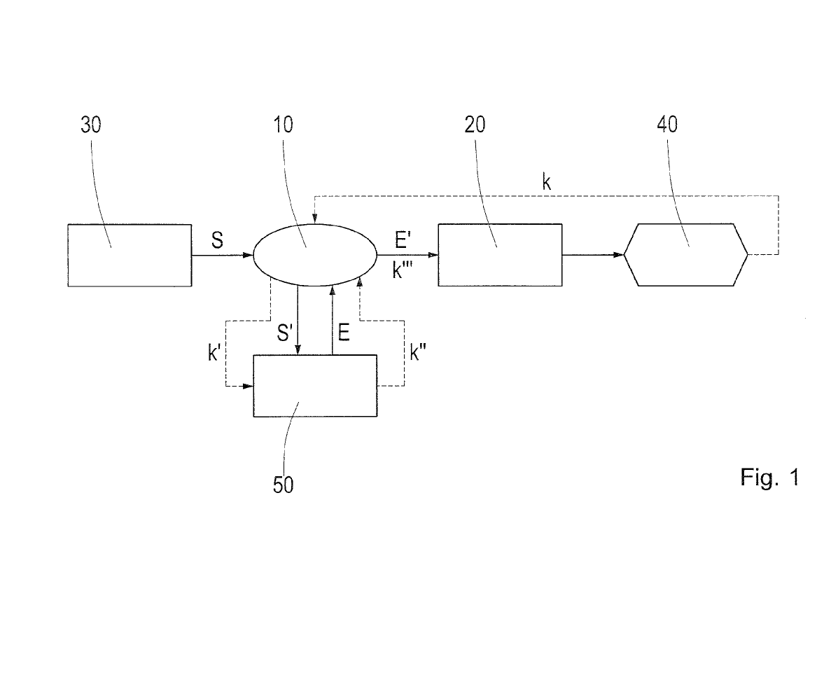

FIG. 1 shows a possible exemplary embodiment of an invention-based arrangement for controlling at least a windshield wiper system and/or windshield washer system, as well as other elements of a vehicle.

The arrangement comprises a control unit 10, which is connected with a drive unit 20, for example, a windshield wiper motor of the windshield wiper system and/or windshield washer system, for controlling the windshield wiper system and/or windshield washer system, wherein the windshield wiper system and/or windshield washer system is representative for different systems or equipment. The control unit 10 is connected with at least one sensor 30 for recording ambient parameters. For example, the sensor can be provided in the form of a rain sensor, contaminant sensor, light sensor, speed sensor, release time assessment sensor or the like. In addition, the control unit 10 is connected with an actuating element 40 of the adaptive control system, which can record correction requests of the driver. For the purpose of storing and reading or retrieving stored wiping intensities for controlling the windshield wiper system and/or windshield washer system, the control unit 10 is connected with a data memory 50. In the data memory 50, at least one characteristic diagram is stored for controlling at least the windshield wiper and windshield washer system, depending on one or multiple ambient parameters, wherein the characteristic diagram can be adapted, depending on the individual correction values.

To control the system via the control unit 10, ambient parameters, for example, rain intensity RI, contamination level, brightness, etc., are transmitted as signal S from the sensor 30 to the control unit 10. The control unit 10 processes signal S and makes a comparison with the values of the characteristic diagram stored in the data memory 50 with regard to signal S′, in order to retrieve from the stored characteristic diagram a wiping intensity E corresponding to signal S′. The control unit 10 processes the resulting wiping intensity E from the data memory 50 and transmits a corresponding control signal E′ for the windshield wiper motor or drive unit 20, thus achieving an appropriate control of the system.

If the resulting control of the system does not correspond to the desire of the driver, he can enter his correction request via the correction request recording actuating element 40 of the adaptive control system. The correction request is supplied as signal k to the control unit 10. The control unit 10 converts the correction request to signal k′ and transmits it to the data memory 50 in order to adapt the wiping intensity stored in the characteristic diagram to correspond to the correction request, so that the data memory 50 transmits signal k″ as corrected wiping intensity to the control unit 10. As a result, the control unit 10 supplies the adapted wiping intensity as corrected control signal k″ of the drive unit 20 to the system, thus achieving a corrected control of the system.

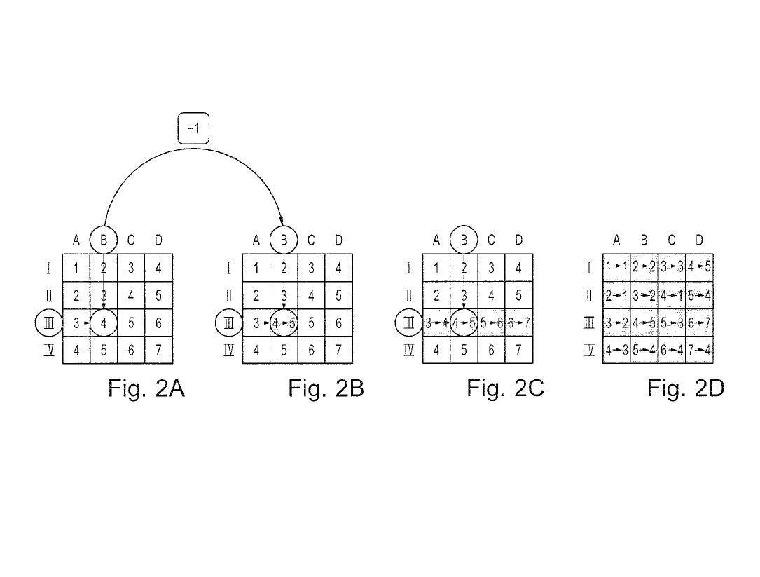

FIGS. 2A to 2D show different views of the invention-based adaptation of wiping intensities stored in a characteristic diagram, wherein the wiping intensity is arranged in Arabic numerals ranging from 1 to 8 in a matrix, depending on multiple ambient parameters. For example, in this two-dimensional matrix, the first stored parameter involves the speed of the vehicle and the second ambient parameter involves the rain intensity RI. The respective matrix shows that the rain intensity is divided in an exemplary manner into four rain intensity categories A, B, C, D, and the speed is also divided into four speed categories I to IV, ranging from low to high. The classification can be arbitrarily extended. It is also possible to add more ambient parameters, resulting in a multidimensional matrix.

FIG. 2A shows that the sensors 30 transmit the rain intensity A at vehicle speed III to the control unit 10, so that the control unit 10 retrieves from the data memory 50 the respectively stored wiping intensity, for example 4, in order to achieve an appropriate control of the system.

In FIG. 2B, the stored matrix or stored characteristic diagram is adapted by a correction request of the driver. In the specific example, the driver desires a correction in the direction of higher wiping intensity in the currently available ambient parameters, so that the wiping intensity is corrected from 4 to 5. This adaptation is stored in the data memory 50.

FIG. 2C shows a version of adaptation in which, for example, as a result of the performed correction at speed III and the rain intensity B, all wiping intensities at vehicle speed III are increased by one level. Further assessments of the performed corrections can be made, in order to achieve simultaneously an advance adaptation of similarly wiping intensities stored.

Finally, FIG. 2D shows an individually adapted matrix after a specific learning phase.

FIGS. 2A to 2D, respectively, show two-dimensional matrices. However, depending on the number of ambient parameters considered, hey can also be arbitrarily performed in multidimensional form.

For example, the driver can perform the correction by using as actuating element 40 push-buttons, rocker switches or the like, which can result in a displacement or reclassification of a currently determined condition in the comparative matrix, for example, by means of more intensive or less intensive wiping. The adapted matrix is stored in the data memory 50 and can be assigned in driver-specific manner, for example, by means of a key ID or the like. To avoid classifications with ambient parameters, for example, of speed categories or rain intensity categories, it is also possible to use an approximation function for approximating individualization between two individually determined values. This counteracts a permanent change of wiping modes, which may be perceived to be disturbing. The correction requests can be stored automatically in specific time intervals, for example, when no change requests are made in a defined time interval. It is also possible that the user initiates the storage or prevents the storage, as required, by activating a specific push-button. With each stored correction request, the desired wiping intensity WI is stored or the already existing values in the characteristic diagram are overwritten, in consideration of the existing ambient parameters. In this way, an individual user profile is prepared in the form of an individual characteristic diagram or matrix. After a specific learning period, an adaption of the wiping intensity by the user is no longer required, which has a positive effect on driving safety and driving comfort.

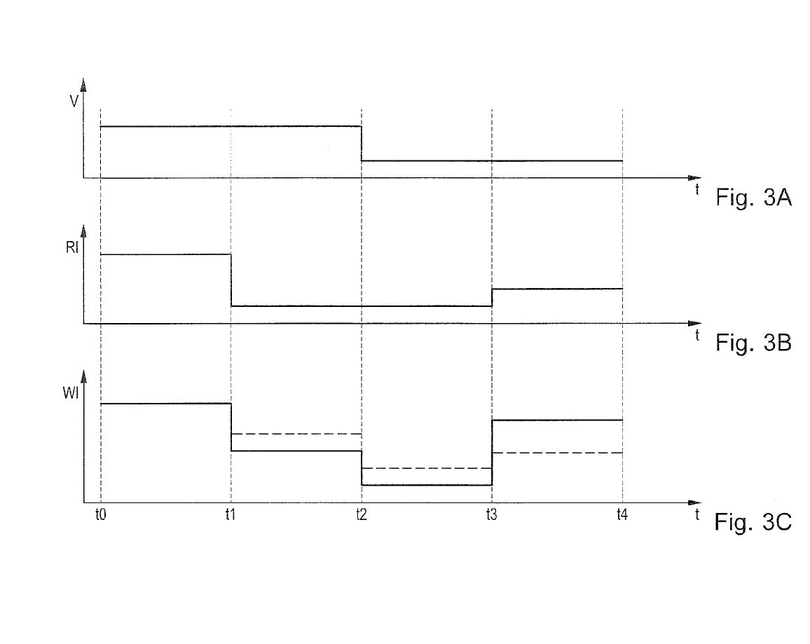

FIG. 3A shows in a diagram an example of a temporal course of the vehicle speed v in a time interval beginning at point t0 and ending at point t4. At the same time, the time interval is applied to the abscissa and the vehicle speed v to the ordinate of the diagram. Beginning at point t0, the vehicle speed has a value v, wherein v≠0. The value of the vehicle speed v at point t0 is identical with the vehicle speed v at point t1 and point t2. As a result, there is no change in vehicle speed v. At point t2, the vehicle speed v is reduced, wherein v≠0 still applies. At points t3 and t4, the vehicle speed v is identical with the value at point t2. Accordingly, there is no further change of the vehicle speed v.

FIG. 3B shows in a further diagram an example of a temporal course of the rain intensity RI in the time interval described in FIG. 3A. As described in FIG. 3A, the time interval is applied to the abscissa and the rain intensity RI to the ordinate of the diagram. At point t0, the rain intensity RI has a value, wherein RI>0. This means that the vehicle window is dealing with rainfall or moisture. At point t1, the rain intensity RI considerably decreases, wherein the value continues to be RI>0. The now reached value of rain intensity RI remains initially the same until an increase of rain intensity RI is recorded at point t3. At the same time, the value of rain intensity RI at point t3 is greater than the value at points t1 and t2, but smaller than the value of rain intensity RI at point t0. There is no further change of rain intensity RI in the time interval between points t3 and t4.

F3C shows in a further diagram an example of a temporal course of the wiping intensity WI in the previously mentioned time interval. As described in FIG. 3A and FIG. 3B, the time interval is applied to the abscissa and the wiping intensity to the ordinate of the diagram. The first course depicted with a continuous line reflects the course of the wiping intensity WI already stored in the characteristic diagram, based on the ambient parameters, here the vehicle speed and rain intensity RI. At point t0, the diagram has a value for the wiping intensity WI, wherein the value comprises WI>0. At point t1 and point t2, a gradual reduction of the wiping intensity WI takes place, wherein the value comprises WI>0. At point t3, an increase of the wiping intensity WI takes place, wherein the value of the wiping intensity WI at point t3 is greater than that at points t1 and t2, but smaller than the value of the wiping intensity WI at point t0. In addition, FIG. 3C shows a second course of the wiping intensity WI by means of a dotted line. This second course of the wiping intensity WI shows the course after a correction request has been made or after the wiping intensity has been changed. In the interval from t0 to t1, the values of the wiping intensity WI are equal. At point t1m the rain intensity RI considerably decreases, which reduces the wiping intensity WI, based on the values stored in the characteristic diagram. However, a correction request is made to a greater wiping intensity WI than the wiping intensity WI provided by the values stored in the characteristic diagram. This is manifested by the fact that the adapted course between t1 and t2 shown on the dotted line has a higher value of the wiping intensity WI than the course of the values stored in the characteristic diagram and shown on the continuous line. The same applies in analogous application for the time interval from t2 to t3. Here the vehicle speed v is decreased at point t2, the rain intensity RI remains the same in comparison to the previous interval section and this results in a decrease of the wiping intensity WI, based on the values stored in the characteristic diagram. However, the user does not want the wiping intensity Wi to be reduced that much, which is reflected in the correction request. Again, the value of the desired wiping intensity WI is greater than the wiping intensity WI provided by the values stored in the characteristic diagram. At point t3, the rain intensity RI increases, which results in an increase of the wiping intensity WI, based on the values stored in the characteristic diagram. However, the user desires a lower increase of the wiping intensity WI, which is reflected in the correction request, because the value of the wiping intensity WI shown in the dotted line is smaller than the wiping intensity WI determined by means of the values stored in the characteristic diagram.

This results in the fact that the vehicle speed v is reduced after point t2, wherein the rain intensity RI is decreased in the time period between t1 and t3. Because of the fact that the rain intensity RI decreases in the time period between t1 and t3, also the wiping intensity WI is decreased beginning at point t1 until point t3. The decrease takes place gradually, because at point t2 also the vehicle speed v is reduced. Since after point t3, the rain intensity RI increases again, the wiping intensity WI is also increased. The dotted line in the time display of the wiping intensity WI corresponds to the adapted wiping intensity WI resulting from the performed correction requests.

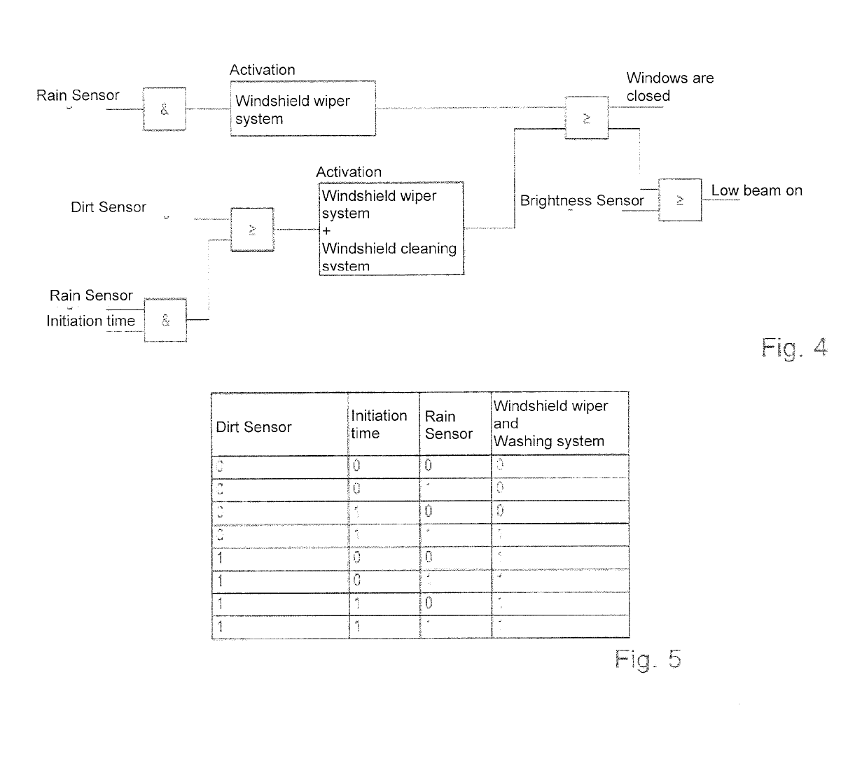

FIG. 4 shows in exemplary manner a possible block diagram regarding the method for controlling in particular a windshield wiper system and a windshield washer or windshield spraying system. For example, by means of the invention-based method, the windshield wiper system and/or windshield washer system can be activated when a determinable rain intensity RI and/or a determinable contamination level and/or a determinable release time is reached. According to FIG. 4, the upper path of the block diagram provides that the windshield wiper system is activated at a predetermined rain intensity and the windows of the vehicle are closed. The lower path of the block diagram provides that the windshield wiper system and windshield washer system are activated at a predetermined contamination level, which is released by the contaminant sensor. If required, it is also possible that the windows are closed. In addition, it is possible that the low-beam light is turned on at a predetermined low brightness, which is recorded by a light sensor. Optionally, it is also possible that the interior illumination or dashboard illumination or the like is activated in addition to the low-beam light. In particular, in vehicles with autonomous drive mode, in which the driver no longer has to control the vehicle, an activation of the interior illumination can be convenient.

As mentioned above, specific sensors for recording the ambient parameters are required for the proposed automatic control system. For example, a rain sensor is used, which detects the moisture or amount of water on the windshield. It is also possible to use a release time assessment sensor, which tracks and assesses manually or automatically the time until the most recent activation. The release time can be further improved with the current season. For example, in winter and spring the sensor could react more sensitive than in summer and fall. Finally, a contaminant sensor is used to determine the level of contamination.

In the context of automatic control, different cases of window contamination can occur in which the windshield wiper system and/or windshield washer system has to react correspondingly.

When previously a period of steady rainfall took place, a desired reaction involved that the windshield wiper system was activated. In the context of the proposed method, also the windshield spraying system should be activated for cleaning the window when the window is contaminated with dirt after a long period of rain during the drive. A light rainfall starts after an extended dry period. A desired reaction would involve that the windshield washer system and the windshield spraying system should be activated to provide a clear view. When in the winter salt water is sprayed on the window, the wiping process results in streaks on the windshield. The desired reaction of the proposed method would involve that the windshield wiper system and windshield washer system or windshield spraying system are activated.

The previously mentioned situations are merely a summary of a variety of possible cases. FIG. 5 shows in tabular form conditions of the different sensors and the windshield wiper system and windshield washer system. The numeral 0 indicates that the respective sensor is not making any detection, and numeral 1 indicates that the sensor has made a detection. The line one of the table shows that the windshield wiper system and windshield washer system are not activated when the provided sensors do not make any detection. According to line two of the table, the same applies to the detection or activation of the rain sensor. The same result is observed in line three, when merely the release time is reached. In line four, the release time and the rain sensor transmit a signal>0, resulting in an activation of the windshield wiper system and windshield washer system. According to line five, the windshield wiper system and windshield washer system are also activated when the contaminant sensor transmits a signal>0, i.e., a predetermined contamination level has been recorded. Line six of the table provides that the contaminant sensor, as well as the rain sensor transmit a signal>0, so that both systems start operating. The same results can be observed in line seven, in which the contaminant sensor transmits a signal>0 and the release time is reached. The last line shows that the transmission of a signal>0 of all sensors activates both the windshield wiper system and windshield washer system.

In the context of the sensor assessment, it is possible to store even more parameters and functions, which are not mentioned in the block diagram for reasons of clarity.

For safety reasons, it can also be provided that the control of the windshield wiper system and windshield washer system can be disconnected manually at any time. In this way, the driver has some kind of an emergency stop in order to prevent any unintended wiping or cleaning of the window in specific situations, for example, in the winter when thawing the window.

The contaminant sensor can be coupled with a trigger or temporal function. For example, in the event that the contamination cannot be removed with customary spraying water. In the case of such contamination, it can be first proceeded as usual. However, after a second repetition, the control should be activated again only within a predetermined period of time. Otherwise, the cleaning liquid could be used up within a very short period of time. At the same time, it has to be determined whether the contaminant sensor receives a permanent signal despite the cleaning process or whether the contaminant sensor is temporarily deactivated and is activated again within a short period of time, as is the case, for example, when saltwater forms streaks on the window. In this case, the windshield washer system should be activated again. In summary, it can be determined that the method is able to distinguish between dirt that cannot be dissolved permanently and frequently occurring new contamination.

It is possible that the required sensors are mounted in each window and the automatic control of the system wipes and/or cleans each window separately.

For example, increased consumption of spraying water can be compensated with the use of rain water. For this purpose, the rain water is cleaned and collected. A detergent dosing device with a cleaning additive adds the cleaning additive in regular intervals to the rain water.

The majority of modern vehicles are provided with light sensors, but they sometimes react too late. With the invention-based method and the connection with the rain sensor, it is possible to turn on the low-beam light when it starts raining on a sunny day, despite bright ambient conditions.

### REFERENCE SYMBOLS

10 control unit

20 drive unit

30 sensor

40 actuating element

50 data memory

A first rain intensity category

B second rain intensity category

C third rain intensity category

D fourth rain intensity category

I first vehicle speed category

II second vehicle speed category

III third vehicle speed category

IV fourth vehicle speed category

S input value of rain intensity transmitted to the control unit

S′ rain intensity processed by the control unit

E wiping intensity stored in the data memory

E′ control signal transmitted by the control unit

k correction signal

k′ correction signal processed by the control unit

k″ correction value stored in the data memory

k″′ corrected control signal transmitted by the control unit

v vehicle speed

RI rain intensity

WI wiping intensity

T0-t4 points

1. An arrangement for controlling at least a windshield wiper system and/or windshield washer system of a vehicle, the arrangement comprising:
at least one sensor for recording ambient parameters;
wherein the sensor is connected via a control unit for purposes of controlling with a drive unit of the windshield wiper system and/or windshield washer system; and
wherein the control unit is connected with a correction request recording actuating element of the windshield wiper system and/or windshield washer system, for providing adaptive control.

2. The arrangement of claim 1, wherein the control unit is connected with at least one data memory for storing and retrieving the recorded individual correction values.

3. The arrangement of claim 2, the arrangement further comprising a characteristic diagram stored in the data memory for controlling at least the windshield wiper system and/or windshield washer system, depending on multiple ambient parameters, wherein the characteristic diagram can be adapted based on the individual correction values.

4. The arrangement of claim 1, wherein at least one of the following sensors is provided as the sensor for recording ambient parameters: rain sensor for recording the rain intensity, contaminant sensor for recording the contamination level of the window, light sensor for recording the ambient brightness, speed sensor for recording the vehicle speed and release time assessment sensor.

5. The arrangement of claim 1, wherein the arrangement can be used in vehicles with autonomous drive mode.

6. A method for adapting a characteristic diagram for controlling a windshield wiper system and/or windshield washer system, depending on ambient parameters, the method comprising:
changing and storing individually, depending on a correction request by a driver, an actuating intensity of the windshield wiper system and/or windshield washer system stored in a characteristic diagram, depending on multiple ambient parameters.

7. The method of claim 6, wherein the individually adapted characteristic diagram is stored and retrieved in driver-specific manner.

8. The method of claim 6, wherein the adapted characteristic diagram is assessed with regard to the correction requests, so that the recorded correction requests are transferred to other stored actuating intensities for adaptation.

9. A method for controlling a windshield wiper system and/or windshield washer system of a vehicle, depending on ambient parameters, the method comprising:
activating the windshield wiper system and/or windshield washer system when a determinable rain intensity and/or a determinable contamination level and/or a determinable release time is reached.

10. The method of claim 9, wherein the activating of the windshield wiper system occurs at a predetermined rain intensity and the windows of the vehicle are closed.

11. The method of claim 9, wherein the windshield wiper and windshield washer system is activated when a predetermined release time and a predetermined rain intensity are reached.

12. The method of claim 9, wherein the windshield wiper and windshield washer system is activated when a predetermined contamination level is reached.

13. The method of claim 11, wherein the windows are closed and at a predetermined low brightness the low-beam light is turned on.

14. The method of claim 6, wherein the method is used in a vehicle with autonomous drive mode.

15. The arrangement of claim 2, wherein at least one of the following sensors is provided as the sensor for recording ambient parameters: rain sensor for recording the rain intensity, contaminant sensor for recording the contamination level of the window, light sensor for recording the ambient brightness, speed sensor for recording the vehicle speed and release time assessment sensor.

16. The arrangement of claim 3, wherein at least one of the following sensors is provided as the sensor for recording ambient parameters: rain sensor for recording the rain intensity, contaminant sensor for recording the contamination level of the window, light sensor for recording the ambient brightness, speed sensor for recording the vehicle speed and release time assessment sensor.

17. The arrangement of claim 2, wherein the arrangement can be used in vehicles with autonomous drive mode.

18. The method of claim 7, wherein the adapted characteristic diagram is assessed with regard to the correction requests, so that the recorded correction requests are transferred to other stored actuating intensities for adaptation.

19. The method of claim 10, wherein the windshield wiper and windshield washer system is activated when a predetermined release time and a predetermined rain intensity are reached.

20. The method of claim 9, wherein the method is used in a vehicle with autonomous drive mode.
